(19) United States
(12) Patent Application Publication
(10) Pub. No.: US 2010/0124531 A1
(43) Pub. Date: May 20, 2010

(54) NICKEL-MANGANESE BINARY COMPOUND ELECTRODE MATERIALS FOR AN ELECTROCHEMICAL SUPERCAPACITOR AND METHOD FOR PREPARING THE SAME

(76) Inventors: Young Jei Oh, Seoul (KR); Oleg Shlyakhtin, Seoul (KR)

Correspondence Address: JONES DAY, 222 EAST 41ST ST, NEW YORK, NY, 10017, US

(21) Appl. No.: 12/492,041

(22) Filed: Jun. 25, 2009

(30) Foreign Application Priority Data
Nov. 17, 2008 (KR) 10-2008-0114111

(51) Int. Cl. H01M 4/52; H01M 4/58; C01G 53/04; C01G 45/00

(52) U.S. Cl. 423/594.3; 428/402; 977/775

(57) ABSTRACT

The present invention relates to nickel-manganese (Ni—Mn) binary compounds useful as an electrode material for electrochemical supercapacitors, which is one of nickel-manganese coprecipitated hydroxides having a spinel-like structure, nickel-manganese coprecipitated hydroxocarbonates having a calcite-like structure and nickel-manganese oxides having an ilmenite-like structure. The present invention also relates to a method of preparing the above nickel-manganese (Ni—Mn) binary compounds by chemical coprecipitation and freeze-drying. Since the nickel-manganese binary compounds according to the present invention show high electrochemical efficiency, good reversibility, excellent specific capacity per unit area, a low capacity fade rate and improved cycle life, they can be effectively used as an electrode material for electrochemical supercapacitors.

The present application claims priority to Korean Patent Application No. 10-2008-114111, filed Nov. 17, 2008, the subject matter of which is incorporated herein by reference in its entirety.

### FIELD OF THE INVENTION

The present invention relates to nickel-manganese (Ni—Mn) binary compounds useful as an electrode material for electrochemical supercapacitors and a method of preparing the same.

### BACKGROUND OF THE INVENTION

Generally, secondary batteries are capable of being recharged, miniaturized in size, and maximized in capacity. Recently, as the demand for portable electronic apparatus (such as small size video cameras, cellular phones, personal notebook computers, PDAs, electric vehicles, automotive subsystems and the like) has increased, improved secondary batteries have been widely developed as power supplies. Representative examples of such secondary batteries include lithium (Li)-based secondary batteries and electrochemical supercapacitors. The lithium-based secondary batteries are rechargeable batteries and show excellent chargeability that can store a large amount of electric energy (high energy density) in a unit weight or unit volume. However, they cannot effectively cope with charging and discharging at high current densities (under high loads), and thus, cannot have high power since the positive electrode active material used therein is inherently a poorly conducting material. Furthermore, since the lithium-based secondary batteries always require a binder, which is an insulating material, the binder interferes with the conductivity of the electrode, and thus the performance of the battery further deteriorates at high current densities.

In contrast, electrochemical supercapacitors are devices in which the electrolyte is placed between two electrode systems. While electrochemical supercapacitors can store and deliver charge in a time scale of the order of several tens of seconds, their ability to deliver charge in short times is dictated by the kinetics of the surface redox (oxidation-reduction) reactions, charge-discharge processes in the electrical double layers and the combined resistivity of the matrix and electrolyte. The electrochemical supercapacitors can have hundreds of times higher energy density than conventional capacitors and thousands of times higher power density than conventional batteries. It should be noted that energy storage in the electrochemical supercapacitors can be both Faradaic or non-Faradaic.

In both the Faradaic and non-Faradaic electrochemical supercapacitors, the capacitance is highly dependent on the characteristics of the electrode and the electrode materials used therein. Ideally, the electrode materials should have a large surface area, low electrical resistance (specific resistance) and a fast response speed.

As such electrode materials for the electrochemical supercapacitor, transition metal oxides which include ruthenium oxide (RuO₂), iridium oxide (IrO₂), cobalt oxide (CoO), molybdenum oxide (MoO₃), tungsten oxide (WO₃), manganese oxide (MnO₂), nickel oxide (NiO) and the like have been widely used in the art. Electrochemical supercapacitors that utilize ruthenium dioxide (RuO₂) as an electrode material have been found to deliver high energy densities and power densities. However, although RuO₂ shows the highest specific capacitance (720 F/g) as compared with the other electrode materials, its application is very restricted due to the tendency of the electrodes to undergo self-discharge, potential recovery resulting in a decrease in cell voltage (and loss of power) over time, and the use of the expensive ruthenium metal. Further, NiO, CoO and MnO₂ are problematic in terms of their poorly reproducible specific capacitance properties. Therefore, there is still a need to develop new transition metal oxides to be used as electrode materials that have high capacity and are cost-effective.

It has been reported that among the currently available electrode materials, ruthenium oxides and hydroxides have relatively high specific capacitance (Kuo-Hsin Chang, et al., Chem. Mater. 19: 2112-2119, 2007; Il-Hwan Kim and Kwang-Bum Kim, Electrochem. Solid State Lett. 4: A62-64, 2001). Specific capacitance of nanocrystalline powders and thin films of ruthenium hydroxides (RuO₂.xH₂O) can achieve 600-650 F/g at a voltage sweep rate of 20 mV/s. However, since the total amount of energy stored in a supercapacitor is proportional to the amount of electrode materials used therein, the ruthenium dioxide supercapacitor requires a significant amount of expensive ruthenium metals, which is an obstacle to commercialization.

PCT International Publication No. WO 2003/088374 and U.S. Pat. Nos. 5,986,876, 6,181,546 and 7,084,002 disclose that nanocrystalline or nanoporous nickel (II) oxides and hydroxides can be successfully used as an electrode material at a moderate discharge current and sweep rate, although the increase in sweep rate to 50-100 mV/s is usually accompanied by a decrease in specific capacitance to 125-135 F/g. U.S. Pat. Nos. 6,339,528 and 6,616,875 disclose a method of fabricating a supercapacitor electrode by mixing manganese (IV) hydroxide powders with carbon black or graphite and coating the resulting mixture on a metal current collector, which showing high specific capacitance over 200 F/g at a sweep rate of 20 mV/s. However, manganese hydroxides (MnO₂.xH₂O) with high capacity values are problematic in terms of the high fade rate of specific capacitance. Further, in case of fabricating this into a thin film electrode, the electrochemical specific capacitance suddenly decreases depending on the thickness of the thin film, and thereby results in lowering the total specific capacitance of the supercapacitor using the electrode.

Taking into account the unique electrochemical behavior of the oxides and hydroxides of various transition metals, it would be reasonable to expect that the complex oxides and hydroxides of the various transition metals will also exhibit similar characteristics. For example, the specific capacitance of Co—Al layered double hydroxides/hydroxocarbonates and Co—Si double hydroxides can achieve 230-250 F/g at a sweep rate of 5-10 mV/s, although their working voltage window is relatively narrow (0.1-0.6 V vs Hg/HgO) (PCT International Publication No. WO 2006/032183).

The present inventors have therefore conducted research to develop a new electrode material having a high specific capacitance, a wide working voltage window and a relatively low fade rate so as to improve the performance of the electrochemical supercapacitor, and found that, when nickel and manganese are used in a binary compound form such as nickel-manganese coprecipitated hydroxides, hydroxocarbonates and oxides, the thus obtained nickel-manganese binary compounds do not cause the deterioration in electrical properties, such as specific surface area, specific resistance, response rate and the like, exhibit high specific capacitance per unit area, and show a low capacitance fade rate during the reversible cycling. Therefore, the nickel-manganese binary compounds according to the present invention can be effectively used as an electrode material for an electrochemical supercapacitor.

### SUMMARY OF THE INVENTION

One of the objectives of the present invention is to provide an electrode material for an electrochemical supercapacitor by using a binary compound of nickel and manganese which shows a high charge-recharge rate (power density), excellent specific capacitance per unit area, a low capacitance fade rate and improved cycle life.

In order to achieve the above objective, one embodiment of the present invention relates to a nickel-manganese (Ni—Mn) binary compound useful as an electrode material for an electrochemical supercapacitor, which is one of nickel-manganese coprecipitated hydroxides having a spinel-like structure, nickel-manganese coprecipitated hydroxocarbonates having a calcite-like structure, and nickel-manganese oxides having an ilmenite-like structure.

Another embodiment of the present invention relates to a method of preparing the above nickel-manganese binary compound in a nanocrystalline particle form by chemical coprecipitation and freeze-drying.

### BRIEF DESCRIPTION OF THE DRAWINGS

The embodiments of the present invention will be described in detail with reference to the following drawings:

FIG. 1 is a graph showing the change in specific capacity of the nickel-manganese coprecipitated hydroxides according to the present invention depending on the various molar ratios of nickel and manganese.

FIGS. 2A and 2B are X-ray diffraction spectra analyzing the change in the crystal structure of the nickel-manganese coprecipitated hydroxides and hydroxocarbonates according to the present invention depending on the various heat treatment temperatures, respectively.

FIGS. 3A and 3B are cyclic voltammetry (CV) graphs showing the current-voltage characteristics of the nickel-manganese coprecipitated hydroxides and hydroxocarbonates according to the present invention, respectively.

FIG. 4 is a chronopotentiometry (CP) graph showing the working voltage window of the nickel-manganese oxides according to the present invention during the reversible cycling.

FIG. 5 is a graph showing the change in the specific capacitance of the nickel-manganese coprecipitated hydroxides according to the present invention that have undergone heat treatment at various temperatures during the reversible cycling at high current densities.

### DETAILED DESCRIPTION OF THE INVENTION

The present invention provides nickel-manganese (Ni—Mn) binary compounds useful as an electrode material for an electrochemical supercapacitor.

Unlike the conventional electrode material employing individual hydroxides or oxides of nickel and manganese, the electrode material for an electrochemical supercapacitor according to the present invention is characterized as employing nickel-manganese (Ni—Mn) binary compounds in the form of nickel-manganese coprecipitated hydroxides, hydroxocarbonates and oxides.

The nickel-manganese binary compound of the present invention is one of nickel-manganese coprecipitated hydroxides having a spinel-like structure, nickel-manganese coprecipitated hydroxocarbonates having a calcite-like structure, and nickel-manganese oxides having an ilmenite-like structure.

As one of the nickel-manganese binary compounds according to the present invention, the nickel-manganese coprecipitated hydroxides having a spinel-like structure can be prepared by the following steps:

1) inducing the coprecipitation of nickel and manganese while adding dropwise a sodium hydroxide (NaOH) aqueous solution or a potassium hydroxide (KOH) aqueous solution to a nickel-manganese acetate (CH₃COOH) aqueous solution or a nickel-manganese nitrate (HNO₃) aqueous solution, to thereby obtain nickel-manganese coprecipitated hydroxide particles; and
2) separating the nickel-manganese coprecipitated hydroxide particles obtained in step 1) from the reactant by filtering, washing and freeze-drying the same, to thereby obtain amorphous nickel-manganese coprecipitated hydroxide powders in a nanocrystalline particle form.

In step 1), the acetate aqueous solution or nitrate aqueous solution in which nickel and manganese are dissolved in a molar ratio of 1:1.8 to 1:3, or 1:2 is prepared. Here, if the molar ratio of nickel and manganese dissolved therein is lower than 1:1.8 or exceeds 1:3, there may be problems with the specific capacitance of the supercapacitor being lowered.

The coprecipitation of nickel and manganese is then carried out by carefully adding drop by drop the sodium hydroxide aqueous solution or potassium hydroxide aqueous solution to the nickel-manganese acetate aqueous solution or nitrate aqueous solution prepared above, thereby generating nickel-manganese coprecipitated hydroxide particles. The coprecipitation in step 1) may be carried out at a temperature of 20 to 90° C. for 2 to 10 hours. Here, the sodium hydroxide aqueous solution or potassium hydroxide aqueous solution may be added dropwise in an amount of 35 to 45 parts by weight based on 100 parts by weight of the nickel-manganese acetate aqueous solution or nitrate aqueous solution. Further, the pH of the reactant may be maintained within the range of 9.5 to 10.5 during the coprecipitation.

In some embodiments of the present invention, the nickel-manganese coprecipitated hydroxide particles are prepared by adding dropwise 400 ml of the 1 M sodium hydroxide aqueous solution to 1,000 ml of the 0.2 M nickel-manganese nitrate aqueous solution in which nickel and manganese nitrates are dissolved in a molar ratio of 1:2 at 90° C. for 10 minutes, and inducing the coprecipitation of nickel and manganese at 20° C. for 2 hours. Here, the pH of the reactant may be maintained at 10 during the coprecipitation.

In step 2), the reactant obtained after the coprecipitation is filtered to separate the nickel-manganese coprecipitated hydroxide particles, which is followed by washing with deionized water and freeze-drying, to thereby obtain amorphous nickel-manganese coprecipitated hydroxide powders in a nanocrystalline particle form. The freeze-drying is essential to prevent the nickel-manganese coprecipitated hydroxide particles from forming hard agglomerates, making it possible to obtain products in a nanocrystalline powder form.

In some embodiments of the present invention, the washed nickel-manganese coprecipitated hydroxide crystals are subjected to freeze-drying under a vacuum of about 5×10⁻² mbar by using a freeze dryer, to thereby obtain amorphous or semiamorphous nickel-manganese coprecipitated hydroxide powders in a nanocrystalline particle form. The thus obtained nickel-manganese coprecipitated hydroxides have a tetragonal spinel-like structure.

Further, as another embodiment of the nickel-manganese binary compounds according to the present invention, the nickel-manganese coprecipitated hydroxocarbonates having a calcite-like structure can be prepared by the following steps:

1) inducing the coprecipitation of nickel and manganese while adding dropwise a mixture of a sodium hydroxide (NaOH) aqueous solution and a sodium carbonate (Na₂CO₃) aqueous solution to a nickel-manganese acetate aqueous solution or a nickel-manganese nitrate aqueous solution, to thereby obtain nickel-manganese coprecipitated hydroxocarbonate particles; and
2) separating the nickel-manganese coprecipitated hydroxide particles obtained in step 1) from the reactant by filtering, washing and freeze-drying the same, to thereby obtain amorphous or crystalline nickel-manganese coprecipitated hydroxocarbonate powders in a nanocrystalline particle form.

In step 1), the nickel-manganese acetate aqueous solution or nitrate aqueous solution is prepared according to the same method as described above for the preparation of the nickel-manganese coprecipitated hydroxides. To the nickel-manganese acetate aqueous solution or nitrate aqueous solution is carefully added an equimolar mixture of a sodium hydroxide aqueous solution and a sodium carbonate aqueous solution so as to induce the coprecipitation of nickel and manganese, thereby generating nickel-manganese coprecipitated hydroxocarbonate particles. The coprecipitation in step 1) may be carried out at a temperature of 20 to 90° C. for 6 to 12 hours. Here, the equimolar mixture of a sodium hydroxide aqueous solution and a sodium carbonate aqueous solution may be added dropwise in an amount of 55 to 65 parts by weight based on 100 parts by weight of the nickel-manganese acetate aqueous solution or nitrate aqueous solution. Further, the pH of the reactant may be maintained within the range of 9.8 to 10.2 during the coprecipitation.

It has been found that it is possible to generate relatively crystalline products having a calcite-like structure according to the above method of coprecipitating nickel and manganese, which is known in the art as a method for synthesizing layered double hydroxides.

In some embodiments of the present invention, to the 0.2 M nickel-manganese nitrate aqueous solution in which nickel and manganese nitrates are dissolved in a molar ratio of 1:2 is added dropwise the 1 M equimolar mixture of a sodium hydroxide aqueous solution and a sodium carbonate aqueous solution 10 minutes so as to induce the coprecipitation of nickel-manganese at 90° C. for 6 to 12 hours. Here, the pH of the reactant may be maintained at 10 during the coprecipitation.

In step 2), the nickel-manganese coprecipitated hydroxocarbonate particles generated in step 1) are filtered, washed and freeze-dried according to the same method as described above for the preparation of the nickel-manganese coprecipitated hydroxides, to thereby obtain nickel-manganese coprecipitated hydroxocarbonate powders in a nanocrystalline particle form. The thus obtained nickel-manganese coprecipitated hydroxocarbonates have a relatively crystalline calcite-like structure.

Furthermore, as a nickel-manganese binary compound according to the present invention, the nickel-manganese oxides having an ilmenite-like structure can be prepared by isothermally heat treating the nickel-manganese coprecipitated hydroxides having a spinel-like structure or nickel-manganese coprecipitated hydroxocarbonates having a calcite-like structure at a temperature of 300 to 400° C. for 1 to 2 hours. The isothermal heat treatment causes the progression of the amorphization of the nickel-manganese coprecipitated hydroxides and nickel-manganese coprecipitated hydroxocarbonates to crystallization, resulting in a conversion into a crystalline phase with a hexagonal structure similar to ilmenite (FeTiO₃). The thus obtained nickel-manganese oxides have a hexagonal ilmenite-like structure.

The electrochemical properties of the nickel-manganese coprecipitated hydroxides, hydroxocarbonates and oxides obtained according to the present invention are analyzed as follows.

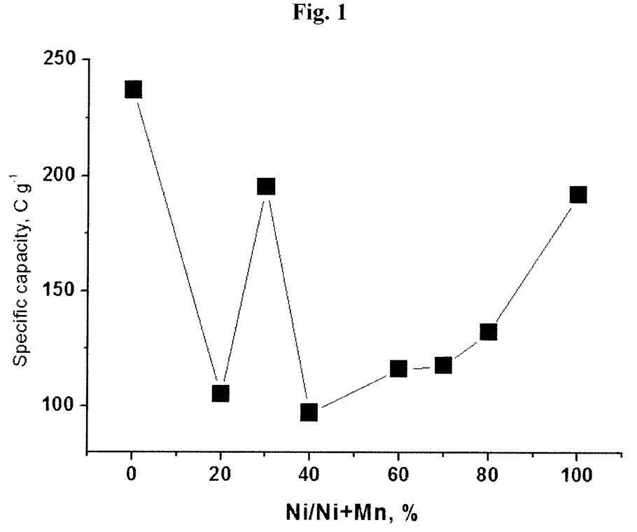

FIG. 1 shows the result of measuring the changes in the specific capacity of the nickel-manganese coprecipitated hydroxides obtained when nickel and manganese are coprecipitated with varying Ni/Mn molar ratios. It has been found that the dependency of the specific capacity on the cationic composition shows a drastically nonlinear graph with three definite peaks. The right and left peaks among the three peaks correspond to nickel hydroxides and manganese hydroxides, respectively, while the middle peak corresponds to the nickel-manganese coprecipitated hydroxides in which nickel and manganese are coprecipitated in a molar ratio of 1:2. In case of fabricating an electrode using the nickel hydroxides or manganese hydroxides alone, the electrode exhibits stable discharge capacity at high current densities and achieves high specific capacity, but is problematic in that its capacitance fade rate relating to the electrode life cycle is increased. However, when an electrode is prepared using the nickel-manganese coprecipitated hydroxides according to the present invention, it can be expected to exhibit high specific capacity, improved energy density and a reasonable capacity fade rate, thereby improving the electrode cycle life.

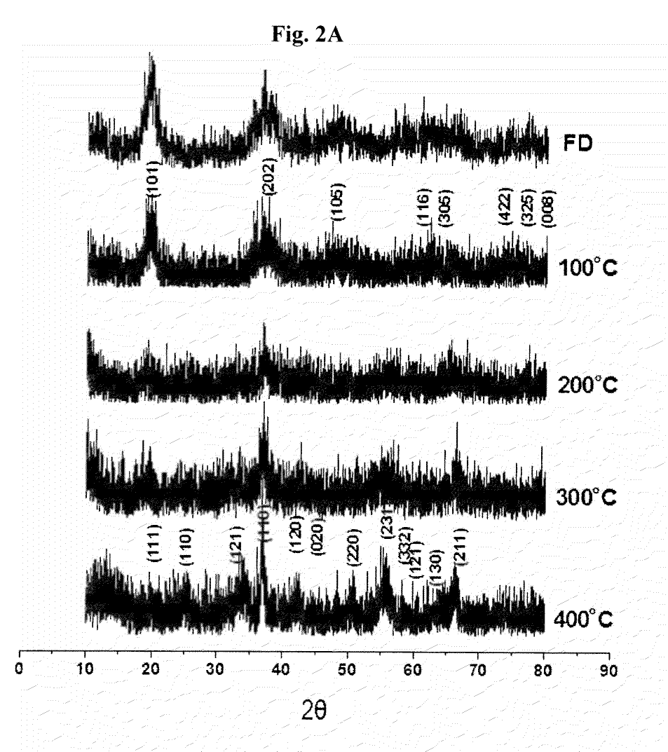

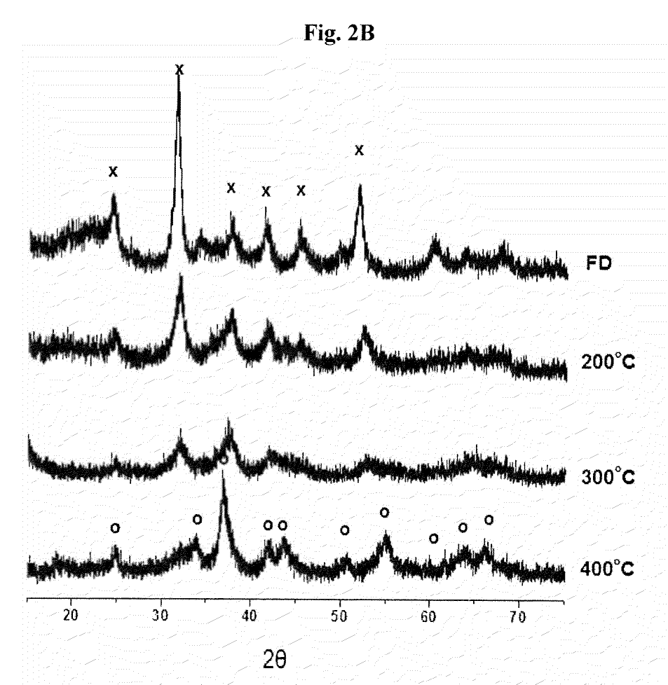

FIGS. 2A and 2B show the results of analyzing the structure and electrochemical behavior of the nickel-manganese coprecipitated hydroxides and hydroxocarbonates (Ni:Mn=1:2) according to the present invention by X-ray diffraction (XRD), respectively. As shown in FIG. 2A, the nickel-manganese coprecipitated hydroxides of the present invention exhibit different crystal structures depending on the various heat treatment temperatures. When treated at 100° C., the nickel-manganese coprecipitated hydroxides have a tetragonal spinel-like structure. As the heat treatment temperature increases to 200 to 300° C., the crystalline phase converts into an almost amorphous phase, which indicates a decrease in the level of crystallographic ordering (crystallinity). When they are heat-treated at 400° C., the amorphous phase of the nickel-manganese coprecipitated hydroxides is transformed into a crystalline hexagonal structure similar to ilmenite (FeTiO₃), thereby generating nickel-manganese=oxides. As illustrated in FIG. 2B, the nickel-manganese coprecipitated hydroxocarbonates shows similar phase evolution to that of the nickel-manganese coprecipitated hydroxides as described above. While they have a plate-type structure similar to calcite, their crystalline structure is transformed into a hexagonal structure similar to ilmenite after the heat treatment at 400° C., thereby generating nickel-manganese oxides.

The nickel-manganese coprecipitated hydroxides having a spinel-like structure, nickel-manganese coprecipitated hydroxocarbonates having a calcite-like structure and nickel-manganese oxides having an ilmenite-like structure as described above are observed under a scanning electron microscope (SEM) and a transmission electron microscope (TEM). As a result, it is found that the nickel-manganese coprecipitated hydroxides and hydroxocarbonates consist of poorly agglomerated isotropic and plate-like crystals having an uniform particle size of 10 to 50 nm, preferably, 20 to 30 nm, respectively, and such a transformation of spinel and calcite to ilmenite does not result in significant morphological change in the above hydroxides and hydroxocarbonates that still maintain their unique nanocrystalline properties.

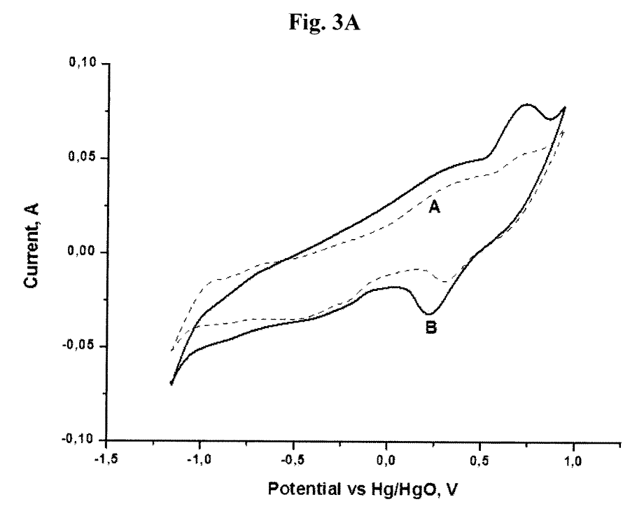

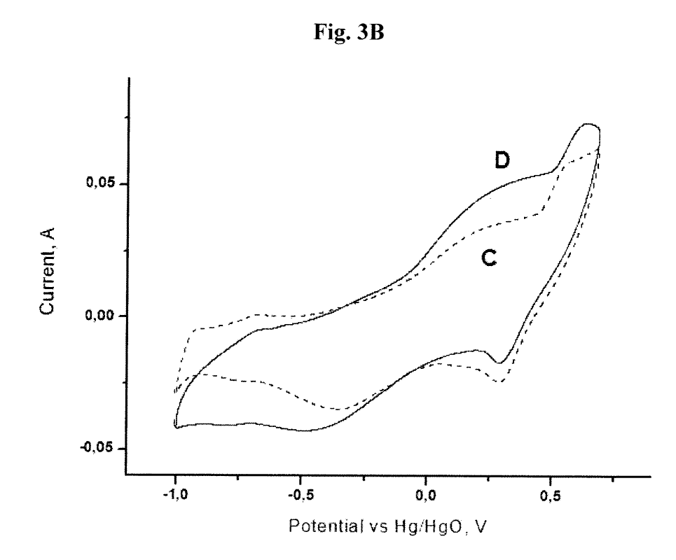

FIGS. 3A and 3B show the results of measuring the current-voltage characteristics of the nickel-manganese coprecipitated hydroxides and hydroxocarbonates (Ni:Mn=1:2) according to the present invention with a cyclic voltammetry (CV), respectively. For this analysis, each of the nickel-manganese coprecipitated hydroxide powders and hydroxocarbonate powders is mixed with carbon black and a PTFE binder in a weight ratio (%) of 80:16:4, and then, to the resulting mixture is added a small amount of ethanol so as to prepare a slurry containing each of the nickel-manganese binary compounds. The slurry is applied onto a Ni foam and dried in air, to thereby prepare an electrode. Here, the nickel-manganese binary compound may be applied in an amount of 8 to 10 mg/cm². A three-electrode cell system employing the thus prepared nickel-manganese coprecipitated hydroxide electrode or nickel-manganese coprecipitated hydroxocarbonate electrode as the working electrode, Hg/HgO as the reference electrode, and Pt foil as the counter electrode is established. The electrochemical behavior of the electrodes is analyzed by using the three-electrode cell system in a 3% KOH electrolyte at a sweep rate of 50 mV/s. In FIG. 3A, A (dotted line) is a CV curve measured relative to the nickel-manganese coprecipitated hydroxide electrode having a spinel-like structure, and B (solid line) is a CV curve measured relative to the nickel-manganese oxide electrode having an ilmenite-like structure which is prepared by heat treatment of the nickel-manganese coprecipitated hydroxides. In FIG. 3B, C (dotted line) is a CV curve measured relative to the nickel-manganese coprecipitated hydroxocarbonate electrode having a calcite-like structure, and D (solid line) is a CV curve measured relative to the nickel-manganese oxide electrode having an ilmenite-like structure which is prepared by heat treatment of the nickel-manganese coprecipitated hydroxocarbonates. The CV curves shown in FIGS. 3A and 3B demonstrate that the energy storage characteristics of the nickel-manganese binary compounds according to the present invention are clearly Faradaic electrochemical reactions. Further, the nickel-manganese binary compounds according to the present invention show an extended working voltage window. As compared with manganese oxides having a working voltage window of 0.6 to 0.7 V, the nickel-manganese oxides of the present invention exhibit an extended working voltage window up to 1.75 to 2 V.

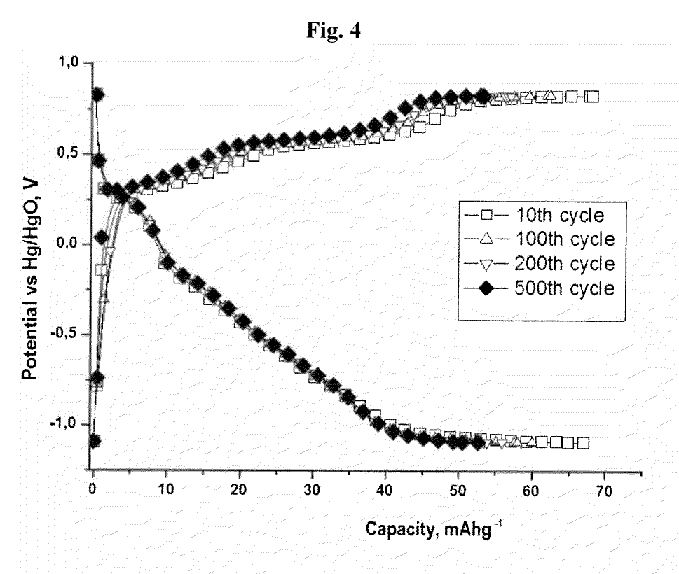

The reversible charge/discharge of the nickel-manganese binary compounds according to the present invention can take place in an alkaline electrolyte solution at a potential in the range of −1.1 to 0.9 V by using an Hg/HgO reference electrode. FIG. 4 depicts the galvanostatic cycling curves of the nickel-manganese oxides having an ilmenite-like structure according to the present invention measured by chronopotentiometry, in which the ascending curves show galvanostatic charge and the descending curves show galvanostatic discharge. A voltage window can be calculated as the difference between the maximum and minimum potentials of an electrode during the reversible cycling. As shown in FIG. 4, it has been found that the extended voltage window observed in the nickel-manganese binary compound electrodes of the present invention is achieved independently by the galvanostatic cycling of these electrodes at high discharge current densities (I) of 50 to 70 mA/cm². The shape of the charge/discharge curves observed in FIG. 4 is not identical to that of a typical electrochemical double-layered capacitor, but it is similar to that showing Faradaic characteristics of an electrochemical battery electrode. The charge/discharge process of the nickel-manganese binary compounds according to the present invention shows excellent reversibility, high electrochemical efficiency of 92% to 95% (Q_{discharge}/Q_{charge}×100%) and a relatively low fade rate of specific capacity, which is totally distinguishable from most of the conventional supercapacitor electrode materials showing an extended voltage window causing rapid degradation. Further, the extended voltage window up to 2 V is very useful for increasing the amount of energy stored in a supercapacitor, which is proportional to Q×V (here, Q is the specific capacity of the electrode material, and V is the voltage window showing the difference between the maximum and minimum potentials of the electrode during the reversible cycling).

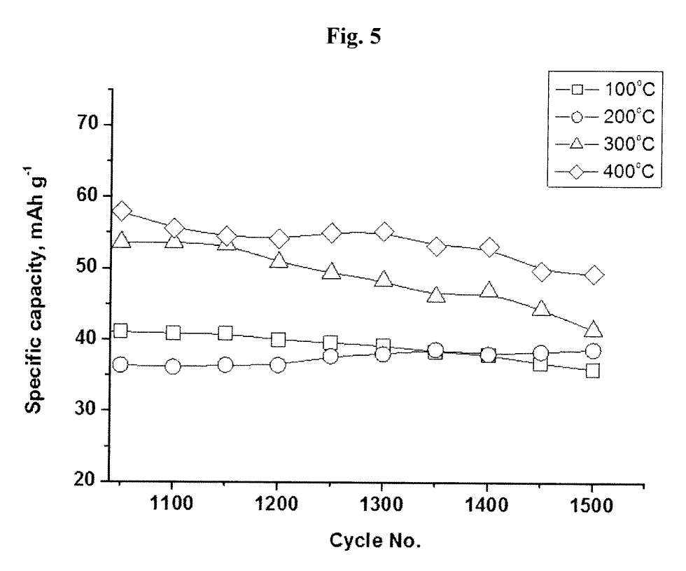

FIG. 5 depicts a graph in which the change in the specific capacitance of the nickel-manganese binary compounds undergoing heat treatment at various temperatures was observed at a high current density of 70 mA/cm² during the reversible cycling. As shown in FIG. 5, the electrode made from the nickel-manganese coprecipitated hydroxide having a spinel-like structure heat-treated at 100° C. has a relatively low specific capacitance, but exhibits excellent cycle durability with little or no reduction of specific capacitance even after 1000 cycles. Further, the nickel-manganese coprecipitated hydroxide electrode shows a partial recovery (20 to 30%) of the specific capacitance during storage in an electrolyte solution. On the other hand, the electrode made from the nickel-manganese oxide electrode having an ilmenite-like structure heat-treated at 400° C. has a significantly higher specific capacitance than the nickel-manganese coprecipitated hydroxide electrode, but it shows a tendency of the specific capacitance to slightly decrease as the cycling takes place more than 1000 times. Although the above cycling may have been carried out at such a high current density that cannot be applied to common chemical batteries, the electrochemical specific capacity of the nickel-manganese oxide electrode having an ilmenite-like structure corresponds to that of a thin film LiCoO₂-based cathode of a lithium battery.

These results demonstrate that the nickel-manganese binary compounds of the present invention show a high specific capacity of 260 C/g or more and a wide voltage window up to 2 V at a high current density (I=70 mA/cm²), while exhibiting a relatively low capacity fade rate.

As described above, the nickel-manganese binary compounds according to the present invention do not cause the deterioration of electrical properties such as specific surface area, specific resistance, response rate and the like, exhibit excellent specific capacity per unit area, show low capacity fade rate during the reversible cycling, and thereby have improved cycle life characteristics as compared with the conventional lithium secondary batteries. Therefore, the nickel-manganese binary compounds according to the present invention can be effectively used as an electrode material for an electrochemical supercapacitor.

While the present invention has been described and illustrated with respect to a number of embodiments of the invention, it will be apparent to those skilled in the art that variations and modifications are possible without deviating from the broad principles and teachings of the present invention, which is defined by the claims appended hereto.

What is claimed:

1. A nickel-manganese (Ni—Mn) binary compound for use as an electrode material for an electrochemical supercapacitor comprising a nickel-manganese coprecipitated hydroxide, a nickel-manganese coprecipitated hydroxocarbonate, or a nickel-manganese oxide.

2. The nickel-manganese (Ni—Mn) binary compound according to claim 1, wherein the nickel-manganese coprecipitated hydroxide has a spinel-like structure.

3. The nickel-manganese (Ni—Mn) binary compound according to claim 1, wherein the nickel-manganese coprecipitated hydroxocarbonate has a calcite-like structure.

4. The nickel-manganese (Ni—Mn) binary compound according to claim 1, wherein the nickel-manganese oxide has an ilmenite-like structure.

5. The nickel-manganese (Ni—Mn) binary compound according to any one of claims 1 to 4, wherein the molar ratio of nickel and manganese in the nickel-manganese binary compound is in the range of from 1:1.8 to 1:3.

6. The nickel-manganese (Ni—Mn) binary compound according to claim 5, wherein the molar ratio of nickel and manganese in the nickel-manganese binary compound is 1:2.

7. The nickel-manganese (Ni—Mn) binary compound according to any one of claims 1 to 4, wherein the nickel-manganese coprecipitated hydroxide, the nickel-manganese coprecipitated hydroxocarbonate and the nickel-manganese oxide are powders in a nanocrystalline particle form having a particle size of 10 to 50 nm.

8. A method of preparing nickel-manganese coprecipitated hydroxides having a spinel-like structure comprising:
inducing a coprecipitation of nickel and manganese while adding dropwise a sodium hydroxide (NaOH) aqueous solution or a potassium hydroxide (KOH) aqueous solution to a nickel-manganese acetate (CH₃COOH) aqueous solution or a nickel-manganese nitrate (HNO₃) aqueous solution, to thereby obtain nickel-manganese coprecipitated hydroxide particles; and
separating the nickel-manganese coprecipitated hydroxide particles from the solution by filtering, washing and freeze-drying the nickel-manganese coprecipitated hydroxide particles, to thereby obtain amorphous or semiamorphous nickel-manganese coprecipitated hydroxide powders in a nanocrystalline particle form.

9. The method according to claim 8, wherein in the acetate aqueous solution or nitrate aqueous solution, nickel and manganese are dissolved in a molar ratio of 1:1.8 to 1:3.

10. The method according to claim 8, wherein the sodium hydroxide aqueous solution or potassium hydroxide aqueous solution is added in an amount of from 35 to 45 parts by weight based on 100 parts by weight of the nickel-manganese acetate aqueous solution or nitrate aqueous solution.

11. The method according to claim 8, wherein the coprecipitation is carried out at a temperature of 20 to 90° C. for 2 to 10 hours while maintaining a pH within the range of 9.5 to 10.5.

12. A method of preparing nickel-manganese coprecipitated hydroxocarbonates having a calcite-like structure comprising:
inducing a coprecipitation of nickel and manganese while adding dropwise a mixture of a sodium hydroxide (NaOH) aqueous solution and a sodium carbonate (Na₂CO₃) aqueous solution to a nickel-manganese acetate aqueous solution or a nickel-manganese nitrate aqueous solution, to thereby obtain nickel-manganese coprecipitated hydroxocarbonate particles; and
separating the nickel-manganese coprecipitated hydroxide particles from the solution by filtering, washing and freeze-drying the nickel-manganese coprecipitated hydroxide particles, to thereby obtain nickel-manganese coprecipitated hydroxocarbonate powders in a nanocrystalline particle form.

13. The method according to claim 12, wherein in the acetate aqueous solution or nitrate aqueous solution, nickel and manganese are dissolved in a molar ratio of 1:1.8 to 1:3.

14. The method according to claim 12, wherein the mixture of a sodium hydroxide aqueous solution and a sodium carbonate aqueous solution is prepared by mixing the sodium hydroxide aqueous solution and sodium carbonate aqueous solution in an equimolar ratio.

15. The method according to claim 12, wherein the mixture of a sodium hydroxide aqueous solution and a sodium carbonate aqueous solution is added in an amount of from 55 to 65 parts by weight based on 100 parts by weight of the nickel-manganese acetate aqueous solution or nitrate aqueous solution.

16. The method according to claim 12, wherein the coprecipitation is carried out at a temperature of 20 to 90° C. for 6 to 12 hours while maintaining a pH within the range of 9.8 to 10.2.

17. A method of preparing nickel-manganese oxides having an ilmenite-like structure comprising:
isothermally heat treating nickel-manganese coprecipitated hydroxides having a spinel-like structure or nickel-manganese coprecipitated hydroxocarbonates having a calcite-like structure at a temperature of 300 to 400° C. for 1 to 2 hours.
